(19) United States
(12) Patent Application Publication
(10) Pub. No.: US 2007/0242907 A1
(43) Pub. Date: Oct. 18, 2007

(54) Roller holder for motion guide device

(75) Inventor: Yan Yu Chen, Taichung (TW)

Correspondence Address: CHARLES E. BAXLEY, ESQ., 90 JOHN STREET, THIRD FLOOR, NEW YORK, NY, 10038, US

(73) Assignee: Hiwin Technologies Corp.

(21) Appl. No.: 11/403,769

(22) Filed: Apr. 13, 2006

(51) Int. Cl. F16C 19/00

(52) U.S. Cl. 384/51

(57) ABSTRACT

A roller holder includes a number of rollers disposed in an outer holding device and partially extended out of the outer holding device and alternately disposed between the rollers and arranged in different direction relative to each other for engaging with different directions between two moving members and for facilitating the sliding movement between the two moving members. The outer holding device includes a number pairs of spacers disposed alternately relative to each other, and retained together with one or more flexible rods for retaining the rollers between the spacers. The spacers each include opposite curved recesses for rotatably receiving the rollers between the spacers.

### BACKGROUND OF THE INVENTION

1. Field of the Invention

The present invention relates to a roller holder, and more particularly to a roller holder having rollers arranged in different directions for engaging between two moving members and for increasing the contact area between the two moving members and for facilitating the sliding movement between the two moving members.

2. Description of the Prior Art

Typical screw shafts comprise a screw member threaded into a nut member, or relatively, a nut member threaded onto a screw member, and a number of balls engaged in the threads of the nut member and the screw member for facilitating the rotational and/or sliding movement between the nut member and the screw member. Normally, the balls are simply disposed in the threads of the nut member and the screw member without any ball holders or retaining devices such that the balls may not be stably retained in place to each other.

Typical motion guide devices, such as linear motion guide devices or other motion guide devices also comprise two moving members, such as a track rail and a slider slidably engaged with each other, and a number of balls or rollers engaged between the two moving members for facilitating the sliding movement between the two moving members.

For example, U.S. Pat. No. 5,947,605 to Shirai disclose one of the typical linear motion guide devices comprising a number of balls engaged between two moving members for facilitating the sliding movement between the two moving members. However, the balls are in point-contact with the two moving members such that the abrasion or scraping between the-two moving members may be increased.

U.S. Pat. No. 6,390,678 to Shirai discloses another typical linear motion guide device comprising a number of rollers engaged between two moving members for increasing the contact between the two moving members and for facilitating the sliding movement between the two moving members. However, the rollers are normally held in place with a roller holder device and are all arranged or disposed in the same or identical direction, such that the rollers may resist the force in only one direction between the two moving members.

The present invention has arisen to mitigate and/or obviate the afore-described disadvantages of the conventional roller holders for the screw shafts or for the linear motion guide devices.

### SUMMARY OF THE INVENTION

The primary objective of the present invention is to provide a roller holder including a number of rollers alternately disposed and arranged in different directions for engaging between two moving members and for increasing the contact area between the two moving members and for facilitating the sliding movement between the two moving members.

In accordance with one aspect of the invention, there is provided a roller holder for engaging between two moving members, the roller holder comprising an outer holding device, a number of first rollers disposed in the outer holding device and partially extended out of the outer holding device, and a number of second rollers disposed in the outer holding device and partially extended out of the outer holding device and disposed alternately between the first rollers and arranged in different direction relative to the first rollers for engaging with different directions between the moving members and for facilitating the sliding movement between the two moving members. The first rollers and second rollers may be stably disposed and retained in the outer holding device in the stable or predetermined position relative to each other.

The outer holding device includes a number pairs of spacers disposed alternately relative to each other for retaining the first and the second rollers between the spacers. The pairs of spacers each include opposite curved recesses for rotatably receiving the first and the second rollers between the spacers.

Each pair of the spacers include a lateral curved recess formed in one side and facing toward each other for rotatably receiving the first rollers between each pair of the spacers. The lateral curved recesses of the spacers are in plan-contact or in line-contact with the first and the second rollers.

Each pair of the spacers include a vertical curved recess formed in one side and facing away from each other for rotatably receiving the second rollers between different pairs of the spacers. The vertical curved recesses of the spacers are in plan-contact or in line-contact with the first and the second rollers.

The outer holding device includes a first rod and at least one second rod disposed parallel to each other, and the pairs of spacers are disposed between the first and the second rods and arranged alternately relative to each other. The first and the second rods are preferably disposed on opposite edge or diagonal portions of the pairs of spacers.

The outer holding device further includes at least one third rod disposed parallel to the first and the second rods, and the pairs of spacers are disposed between the first and the second and the third rods.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a screw shaft or a motion guide device having a roller holder in accordance with the present invention engaged therein and engaged between two moving members;

FIG. 2 is a partial cross sectional view taken along lines 2-2 of FIG. 1;

FIG. 3 is a perspective view illustrating a linear motion guide device having a roller holder in accordance with the present invention engaged therein and engaged between two moving members;

FIG. 4 is a partial perspective view of the roller holder;

FIG. 5 is a partial plan schematic view of the roller holder;

FIG. 6 is another partial plan schematic view of the roller holder, as seen from the other direction of that shown in FIG. 5;

FIG. 7 is a partial cross sectional view of the roller holder, taken along lines 7-7 of FIG. 6;

FIG. 8 is a partial perspective view illustrating an outer holding device of the roller holder;

FIGS. 9, 10 are partial cross sectional views similar to FIG. 7, illustrating the other arrangements of the roller holder;

FIG. 11 is a partial plan schematic view similar to FIG. 5, illustrating the further arrangement of the roller holder;

FIG. 12 is a partial perspective view illustrating an outer holding device of the roller holder as shown in FIG. 11;

FIG. 13 is a partial cross sectional view similar to FIGS. 7 and 9-10, and taken along lines 13-13 of FIG. 14, illustrating the still further arrangements of the roller holder; and

FIG. 14 is a partial cross sectional view taken along lines 14-14 of FIG. 13.

### DETAILED DESCRIPTION OF THE PREFERRED EMBODIMENT

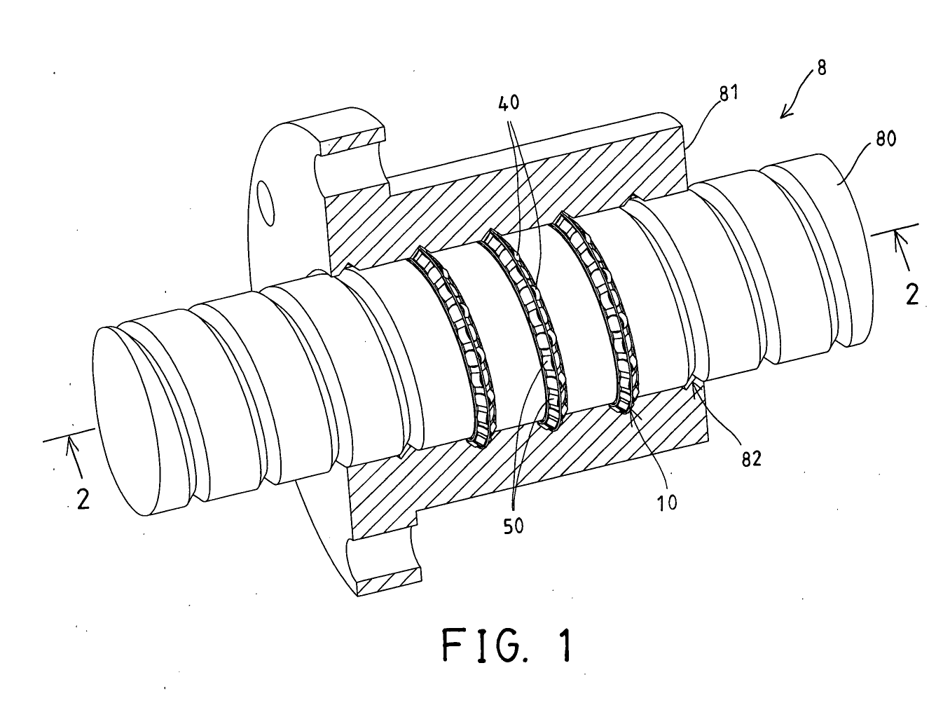

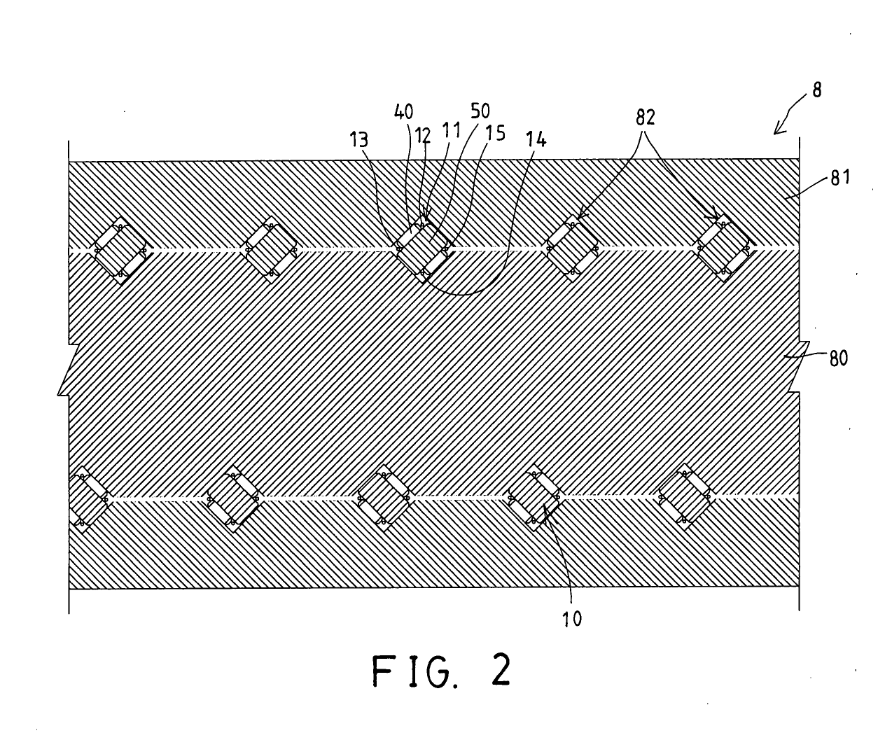

Referring to the drawings, and initially to FIGS. 1 and 2, a roller holder 10 in accordance with the present invention is provided for being engaged in a screw shaft device 8, such as engaged between a screw member 80 and a nut member 81 of the screw shaft device 8, and particularly engaged between the thread members 82 of the screw member 80 and the nut member 81, for facilitating the sliding movement between the two moving members or between the screw member 80 and the nut member 81.

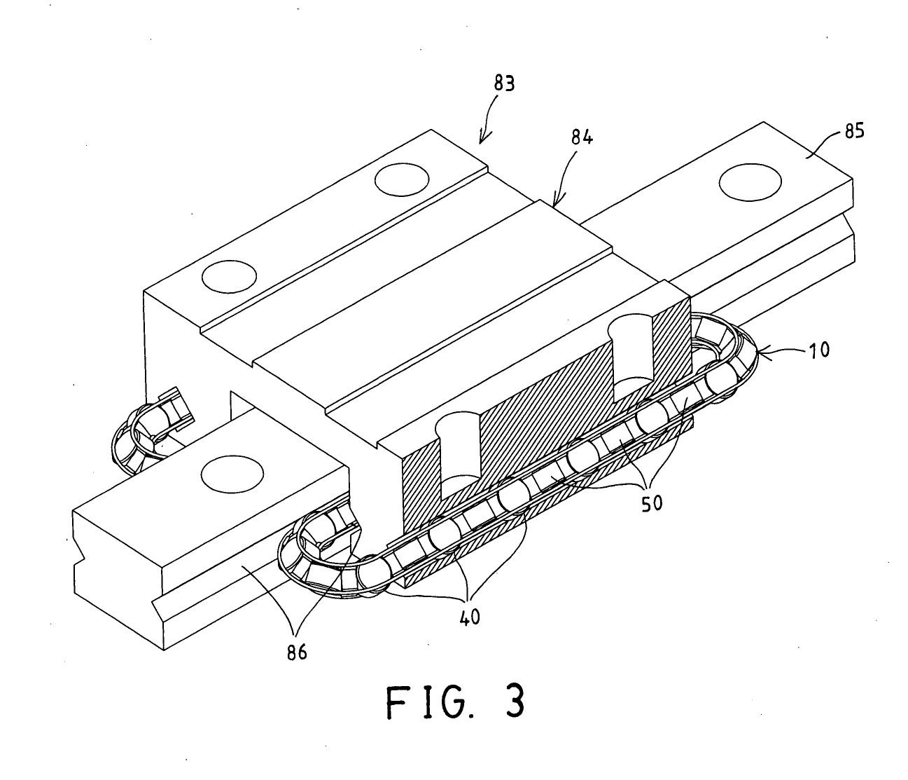

As shown in FIG. 3, the roller holder 10 in accordance with the present invention may also be provided for being engaged in a linear motion guide device 83, such as engaged between a slider 84 and a track rail 85 of the linear motion guide device 83, and particularly engaged between the guiding channels of the slider 84 and the track rail 85, for facilitating the sliding movement between the slider 84 and the track rail 85 of the linear motion guide device 83. Similarly, the roller holder 10 in accordance with the present invention may be provided for facilitating the moving or sliding movement between any other two moving members that are moved relative to each other.

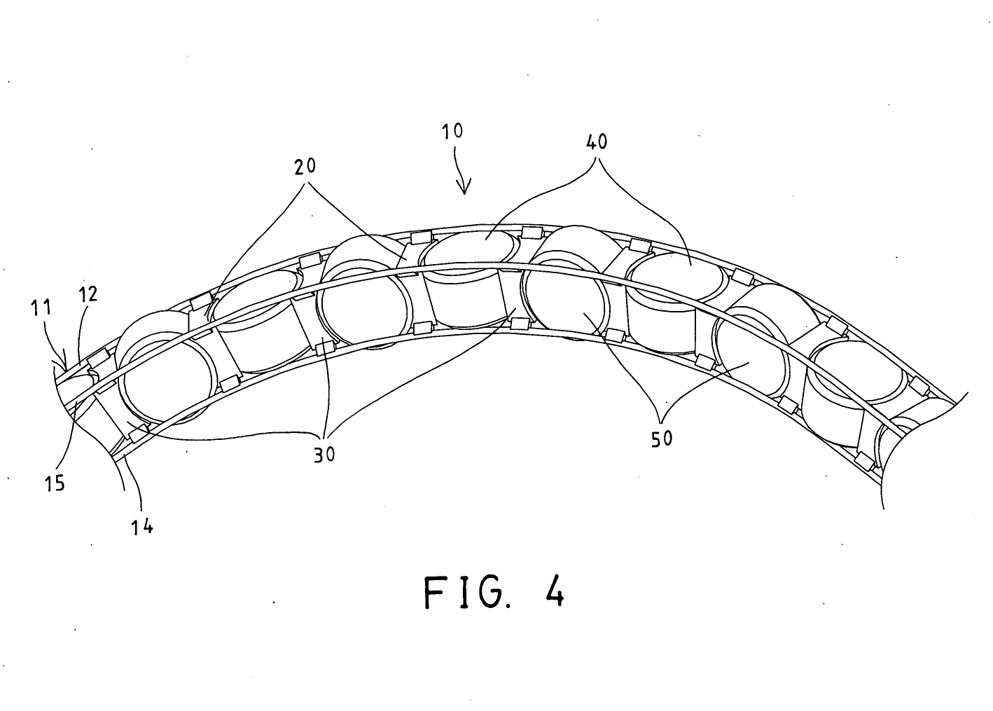

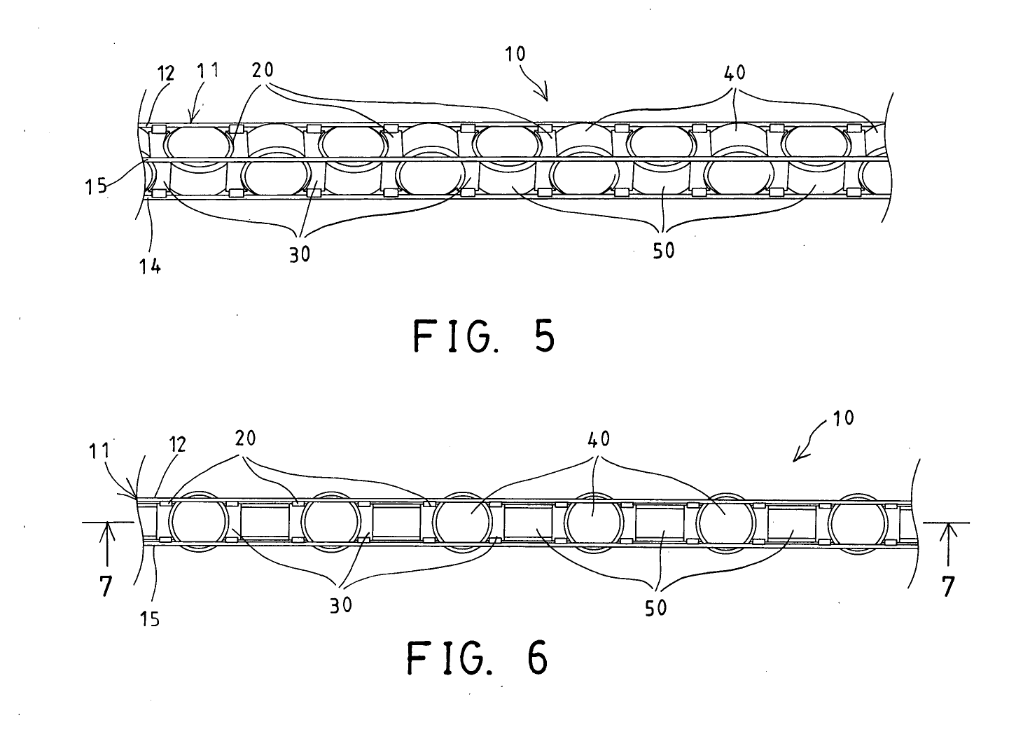

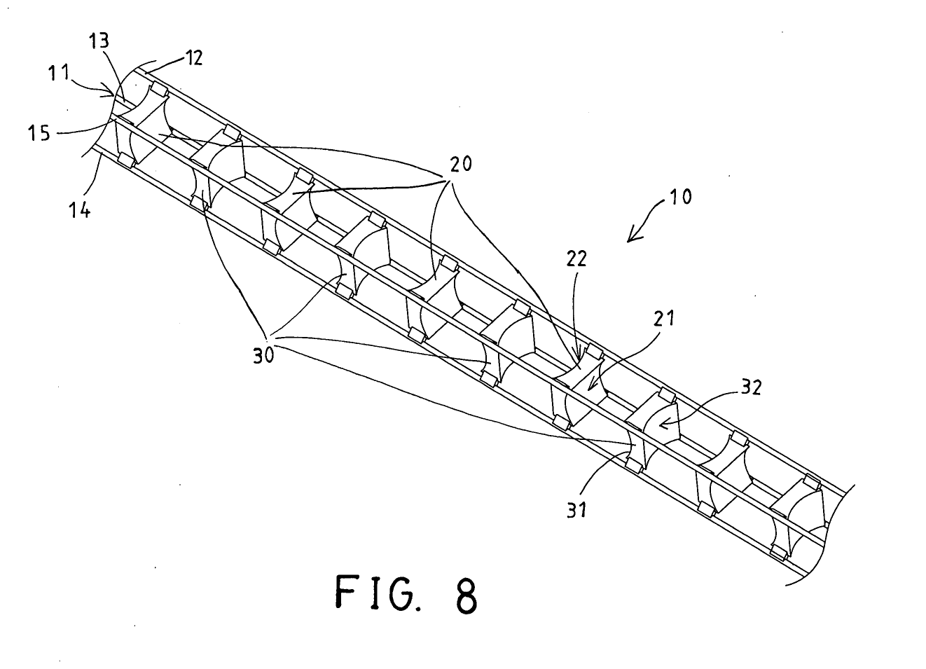

Referring next to FIGS. 4-7, the roller holder 10 in accordance with the present invention comprises an outer holding device 11 including two or more, such as four longitudinal and flexible cables or rods 12, 13, 14, 15 disposed or arranged parallel to each other, and arranged in such as four edge portions of a substantially parallelepiped structure, and a number pairs of spacers 20, 30 disposed between the rods 12-15 and arranged alternately relative to each other. Each pair of spacers 20, 30 include a curved recess 21, 31, such as a lateral or horizontal curved recess 21, 31 formed therein, such as formed in one side or inner or first side thereof, and facing toward each other for rotatably receiving a lateral or horizontal roller 40 therein, as best shown in FIG. 8.

Each pair of spacers 20, 30 further include a curved recess 22, 32, such as a vertical curved recess 22, 32 formed therein, such as formed in the other side or outer or second side thereof, and facing away from each other for rotatably receiving a vertical roller 50 between different pairs of spacers 30, 20, in which the lateral or horizontal rollers 40 are arranged in different direction relative to the vertical rollers 50 or perpendicular to the vertical rollers 50, best shown in FIGS. 4-7, such that one or more included angles may be formed between the horizontal rollers 40 and the vertical rollers 50 when viewing from either of the end portions of the outer holding device 11 . The curved recesses 21, 31, and 22, 32 may thus be formed in the opposite sides of the spacers 20, 30 for rotatably receiving the lateral or horizontal rollers 40 and the vertical roller 50 between the spacers 20, 30.

The lateral or horizontal rollers 40 and the vertical rollers 50 may thus be alternately disposed or received in the outer holding device 11 and partially extended out of the outer holding device 11, and arranged in different direction relative to each other, such as perpendicular to each other for engaging between the two moving members 80, 81 or 84, 85, and for facilitating the sliding movement between the two moving members 80, 81 or 84, 85 that will be moved or slid relative to each other.

In operation, as best shown in FIG. 2, the lateral or horizontal rollers 40 and the vertical rollers 50 are arranged in different direction relative to each other or are perpendicular to each other, for allowing the rollers 40 to resist the force in one direction between the two moving members 80, 81 (FIGS. 1, 2) or 84, 85 (FIG. 3), and for allowing the other rollers 50 to resist the force in the other direction between the two moving members 80, 81 or 84, 85, and for allowing the rollers 40, 50 to suitably facilitate the sliding movement between the two moving members 80, 81 or 84, 85. The rollers 40, 50 may be in line-contact with the two moving members 80, 81 or 84, 85 for reducing the abrasion or scraping between the two moving members 80, 81 or 84, 85.

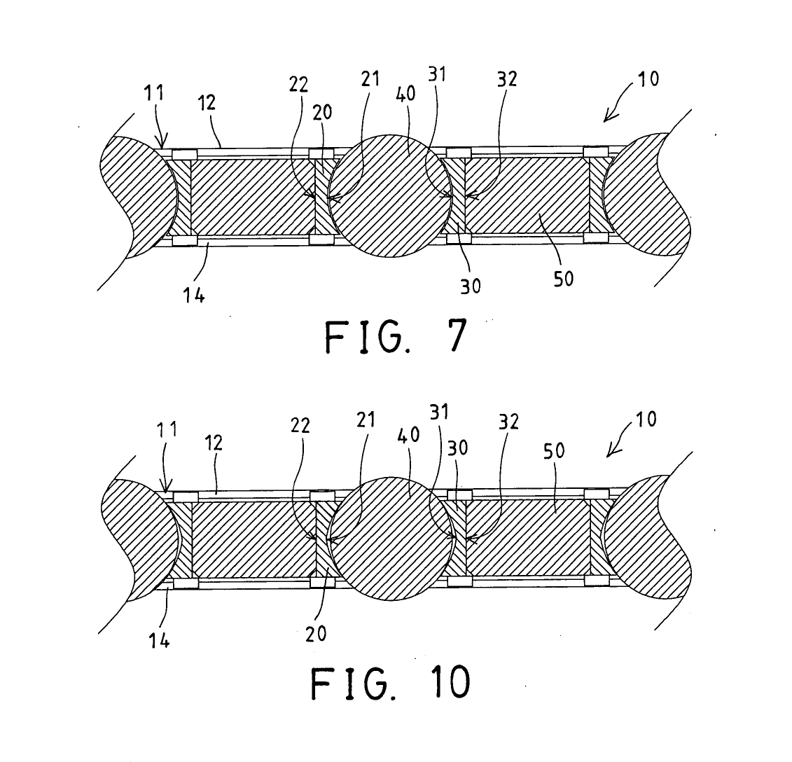

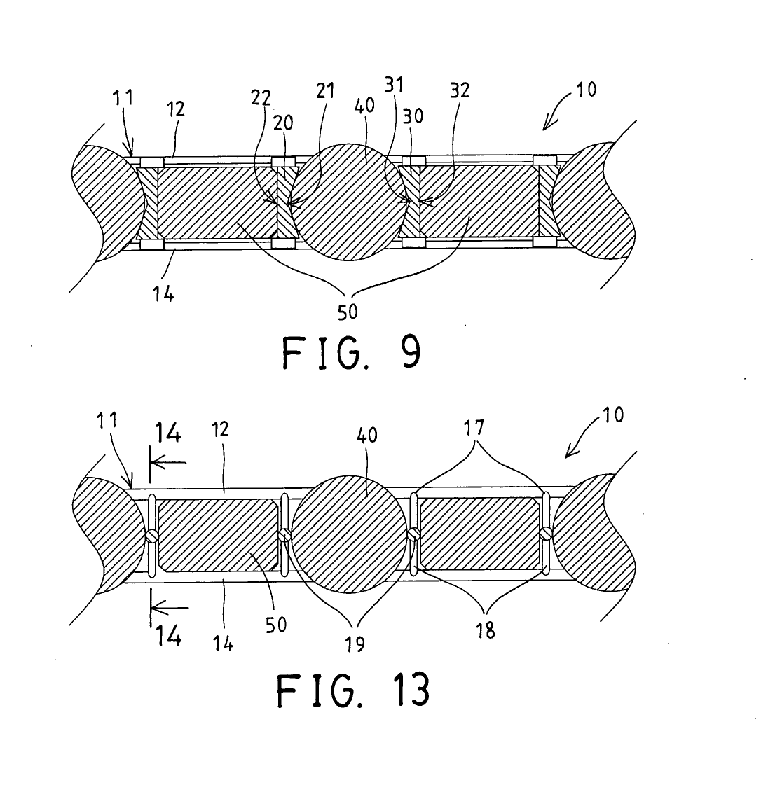

As shown in FIG. 7, the curved recesses 21, 31, and 22, 32 of the spacers 20, 30 may include a curvature corresponding to that of the rollers 40, 50 for allowing the rollers 40, 50 to be in surface or plan-contact with the spacers 20, 30. Alternatively, as shown in FIGS. 9 and 10, the curved recesses 21, 31, and 22, 32 of the spacers 20, 30 may include a curvature different from that of the rollers 40, 50 for allowing the rollers 40, 50 to be in line-contact with the spacers 20, 30. It is preferable that the rollers 40, 50 include a diameter greater than the width or thickness thereof for forming a rectangular cross section, best shown in FIGS. 2, 6-7, 9-10.

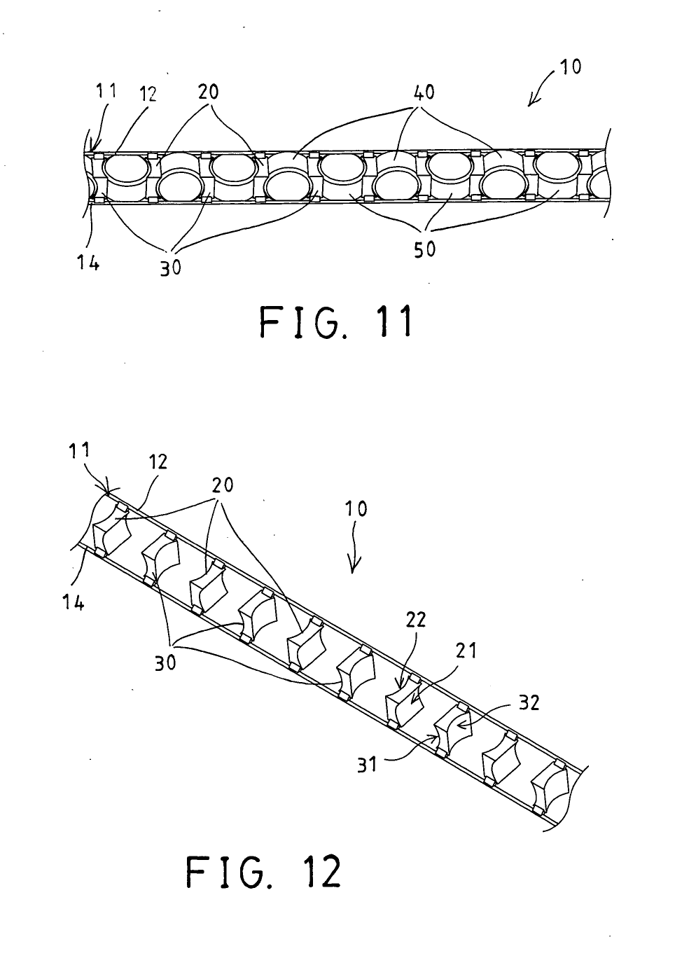

As shown in FIGS. 11 and 12, the outer holding device 11 may include only two or more longitudinal and flexible cables or rods 12, 14 disposed or arranged parallel to each other, and arranged in such as two opposite edge portions or diagonal portions of a substantially parallelepiped structure, and the two longitudinal and flexible cables or rods 12, 14 are good enough to hold and retain the pairs of spacers 20, 30 between the rods 12 and 14. The spacers 20, 30 and the cables or rods 12, 14 may be made of the same or different flexible materials, and may be formed by such as molding or mold injection processes.

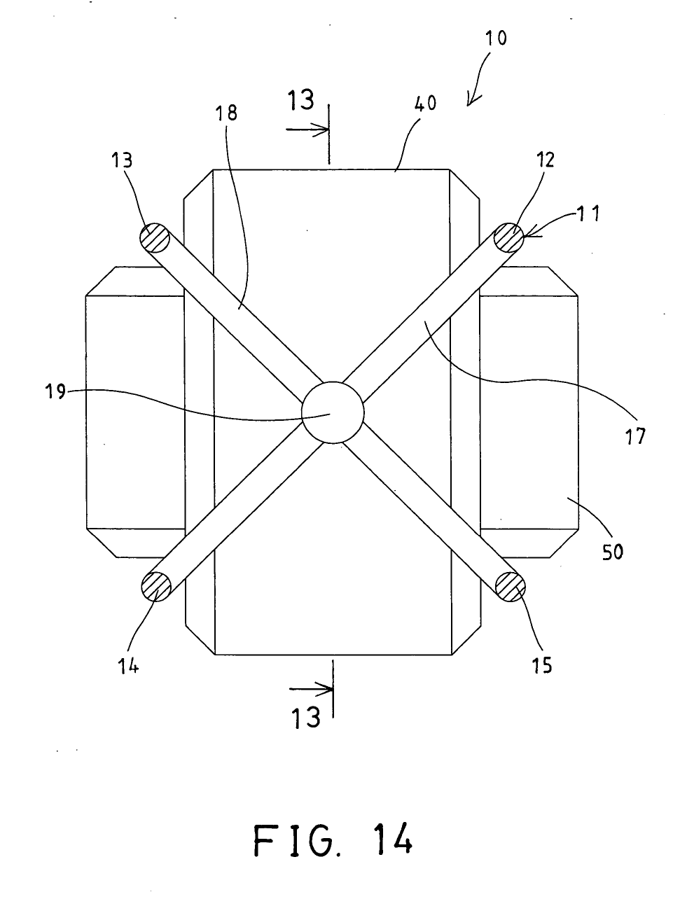

Alternatively, as shown in FIGS. 13 and 14, without the pairs of spacers 20, 30 between the rods 12-15, the outer holding device 11 may include a number of extensions 17, 18 extended from the cables or rods 12-15 respectively, and a ball 19 formed or provided or attached between the extensions 17, 18 for engaging with the rollers 40, 50 and for retaining the rollers 40, 50 between the cables or rods 12-15 and the pairs of spacers 20, 30. The typical screw shaft devices or the typical linear motion guide devices fail to provide a number of rollers 40 arranged alternately relative to each other and arranged in different direction relative to each other or perpendicular to each other for engaging with different directions between two moving members.

Accordingly, the roller holder in accordance with the present invention includes a number of rollers alternately disposed and arranged in different directions for engaging between two moving members and for increasing the contact area between the two moving members and for facilitating the sliding movement between the two moving members.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A roller holder for engaging between two moving members, said roller holder comprising:
an outer holding device including a first rod,
a plurality pairs of spacers disposed in said outer holding device and coupled to said first rod, and disposed alternately relative to each other,
a plurality of first rollers disposed in said outer holding device, and
a plurality of second rollers disposed in said outer holding device and disposed alternately between said first rollers and arranged in different direction relative to said first rollers for engaging with different directions between the moving members and for forming at least one included angle between said first rollers and said second rollers, and
said first rod being disposed in said at least one included angle which is formed between said first rollers and said second rollers.

2. The roller holder as claimed in claim 1, wherein said outer holding device includes at least one second rod coupled to said spacers, said first and said at least one second rods are disposed on diagonal portions of said pairs of spacers.

3. The roller holder as claimed in claim 1, wherein said pairs of spacers each include opposite curved recesses for rotatably receiving said first and said second rollers between said spacers.

4. The roller holder as claimed in claim 3, wherein each pair of said spacers include a lateral curved recess formed in one side and facing toward each other for rotatably receiving said first rollers between each pair of said spacers.

5. The roller holder as claimed in claim 4, wherein said lateral curved recesses of said spacers are in plan-contact with said first and said second rollers.

6. The roller holder as claimed in claim 4, wherein said lateral curved recesses of said spacers are in line-contact with said first and said second rollers.

7. The roller holder as claimed in claim 3, wherein each pair of said spacers include a vertical curved recess formed in one side and facing away from each other for rotatably receiving said second rollers between different pairs of said spacers.

8. The roller holder as claimed in claim 7, wherein said vertical curved recesses of said spacers are in plan-contact with said first and said second rollers.

9. The roller holder as claimed in claim 7, wherein said vertical curved recesses of said spacers are in line-contact with said first and said second rollers.

10. The roller holder as claimed in claim 1, wherein said outer holding device includes at least one third rod disposed parallel to said first and said at least one second rods, and said pairs of spacers are disposed between said first and said at least one second and said at least one third rods.
